(19) United States
(12) Patent Application Publication
(10) Pub. No.: US 2004/0100426 A1
(43) Pub. Date: May 27, 2004

(54) Field emission display brightness uniformity compensation system and method

(76) Inventors: Madhukar Gaganam, Corvallis, OR (US); Krishna A. Rao, Milpitas, CA (US); Don L. Danielson, Palo Alto, CA (US)

Correspondence Address: WAGNER, MURABITO & HAO LLP, Two North Market Street, Third Floor, San Jose, CA, 95113, US

(21) Appl. No.: 10/302,261

(22) Filed: Nov. 21, 2002

(51) Int. Cl. G09G 3/20

(52) U.S. Cl. 345/75.2

(57) ABSTRACT

A present invention field emission display brightness compensation system and method is capable of providing uniform display correction. In one present compensation system and method a masking process is utilized that adjusts the emissions for a particular area. In one exemplary implementation, the relative value of a pixel driver voltage is adjusted to correspond to a base brightness area. For example, an emitter uniformity area adjustment table is utilized to adjust the voltage value of the emitters. An emitter uniformity area adjustment table provides a correlation between a pixel location and a brightness level adjustment. The emitter uniformity area adjustment tables are utilized to create a software filtering mask that provides compensation for uniformity differences between different spots or areas in the display.

### BACKGROUND OF THE INVENTION

1. Field of the Invention

This invention relates to the field of information displays. In particular, the present invention relates to a system and method for efficiently adjusting display devices.

2. Related Art

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data in most areas of business, science, education and entertainment. Frequently, these electronic technologies are utilized to convey information. Displaying information in a visual presentation is usually a convenient and effective method of conveying the information. However, poor quality or distorted displays typically impede information presentation and user comprehension. There are a number of conditions that adversely effect the performance of the display components and impede the presentation of information.

Numerous electronic systems and devices are utilized to convey information. For example, computer systems typically include a display monitor for displaying information. Display devices such as cathode ray tube (CRT) devices and field emission display (FED) devices usually generate light by impinging high-energy electrons on a picture element (pixel) of a phosphor screen and the phosphor converts the electron energy into visible light. The emitted light is utilized to convey images to observers and the properties of the emitted light have a significant impact on the perceptibility of the presentation. The greater the light emission the greater the presentation clarity.

Different types of displays such as cathode ray tubes (CRTs) and field emission devices (FEDs) usually differ in the manner in which the high energy electrons are impinged on a pixel. Conventional CRT displays typically use a single or in some cases three electron beams to scan across the phosphor screen in a raster pattern. FEDs usually utilize stationary electron beams for each color element of each pixel, enabling the distance form the electron source to the screen to be very small compared to the distance required for the scanning electron beams of a conventional CRT. In addition, the vaccum tube of the FED is usually made of much thinner glass and consume less power than a conventional CRT.

The performance of components in field emission displays are usually impacted by a variety of conditions. The emission characteristics of components included in a FED display are often adversely impacted by a number of things. Temperature changes usually have an adverse impact on FED components and often cause changes in the emission characteristics over time. These devices are usually driven with a predetermined voltage designed to result in a particular display intensity. However, emission characteristics of components within display devices often change producing areas of different uniformity. Displays typically have some areas that are brighter than other areas. The adverse effects of these detrimental differences in intensity usually adversely impact the presentation of information and images on a field emission display.

What is required is a system and method for compensating for adverse impacts of differing uniformity in display intensity.

### SUMMARY OF THE INVENTION

The present invention is a system and method for monitoring field emission display (FED) performance and compensating for adverse impacts associated with different uniformity in display intensity. A present invention brightness compensation system and method is capable of providing presentation display uniformity. In one present field emission display brightness uniformity compensation system and method masking process is utilized that adjusts the emissions for a particular area. In one exemplary implementation, the relative value of a pixel driver voltage is adjusted to correspond to a base brightness area. In one exemplary implementation an emitter uniformity area adjustment value table is utilized to adjust the voltage value of the emitters. An emitter uniformity area adjustment table provides a correlation between a pixel location and a brightness level adjustment function value. In one exemplary implementation emitters have brightness levels of 0 to 255 and when rending of a particular pixel address is performed the brightness level is adjusted by an adjustment value factor indicated in the emitter uniformity area adjustment value table. For example, an adjustment value factor of 0.7 on a “red” emitter, 0.8 on a “blue” emitter and 0.5 on a “green” emitter. In one embodiment of the present invention, the emitter uniformity area adjustment value tables are utilized to create a software filtering mask to compensate for uniformity differences between different spots or areas in the display.

### BRIEF DESCRIPTION OF THE DRAWINGS

FIG. 1 illustrates a multi-layer structure which is a cross-sectional view of a portion of an FED flat panel display implementation of one embodiment of the present invention.

FIG. 2 illustrates a portion of an exemplary FED screen utilized in one embodiment of the present.

FIG. 3 is an schematic of an adjusting FED, one embodiment of the present invention.

FIG. 4 is a block diagram of one embodiment of a computer system utilizing a present invention FED.

FIG. 5A is a flow chart of an emission compensation method, one embodiment of the present invention.

FIG. 5B is a flow chart of a uniformity adjustment value table formation process in accordance with one embodiment of the present invention.

### DETAILED DESCRIPTION OF THE INVENTION

Reference will now be made in detail to the preferred embodiments of the invention, a field emission display brightness uniformity compensation system and method, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

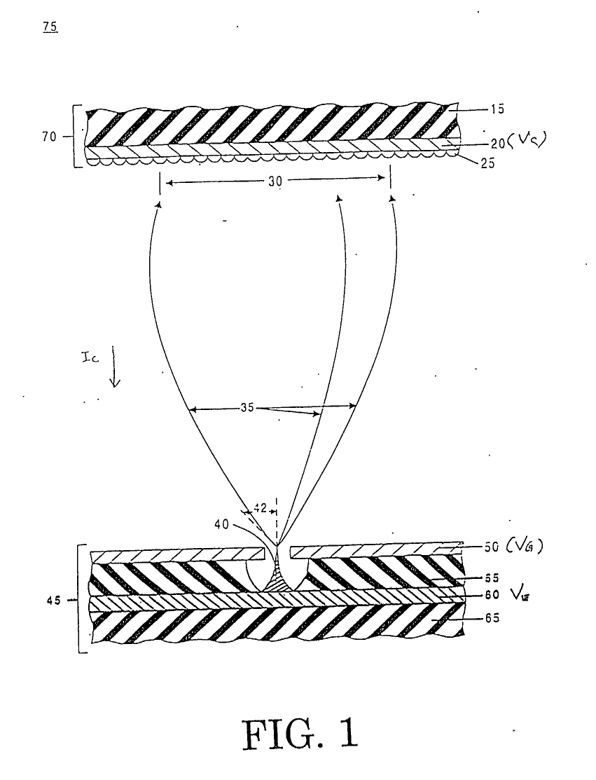

FIG. 1 illustrates a multi-layer structure 75 which is a cross-sectional view of a portion of one embodiment of a flat panel field emission display (FED). The multi-layer structure 75 contains a field-emission backplate structure 45, also called a baseplate structure, and an electron-receiving faceplate structure 70. An image is generated at faceplate structure 70. Backplate structure 45 commonly comprises an electrically insulating backplate 65, an emitter electrode 60, an electrical insulating layer 55, a patterned gate electrode 50, and an electron emissive element 40 situated in an aperture through insulating layer 55. One type of electron-emissive element 40 is described in U.S. Pat. No. 5,608,283, issued on Mar. 4, 1997 to Twichell et al. and another type is described in U.S. Pat. No. 5,607,335, issued on Mar. 4, 1997 to Spindt, et al. which are both incorporated herein by reference. The tip of the electron-emissive element 40 is exposed through a corresponding opening in gate electrode 50. Faceplate structure 70 is formed with an electrically insulating faceplate 15, an anode 20, and a coating of phosphors 25. Electrons emitted from element 40 are received by phosphors portion 30. In one embodiment, electron emissive element 40 includes a conical molybdenum tip. In other embodiments of the present invention, the anode 20 may be positioned over the phosphors 25, and the emitter 40 may include other geometrical shapes such as a filament, carbon fibers, or nanotubes.

The emission of electrons from the electron-emissive element 40 is controlled by applying a suitable voltage (VG) to the gate electrode 50. Another voltage (VE) is applied directly to the electron-emissive element 40 by way of the emitter electrode 60. Electron emission increases as the gate-to-emitter voltage (e.g., VG minus VE) is increased. Directing the electrons to the phosphor 25 is performed by applying a high voltage Vc to the anode 20. When a suitable gate-to-emitter voltage (VGE) is applied, electrons are emitted from electron-emissive element 40 at various values of off-normal emission angle theta 42. The emitted electrons follow nonlinear (e.g. parabolic) trajectories indicated by lines 35 in FIG. 1 and impact on a target portion 30 of the phosphors 25. Thus, VG and VE determine the magnitude of the emission current (IC) while the anode voltage (VC) controls the direction of the electron trajectories for a given electron emitted at a given angle.

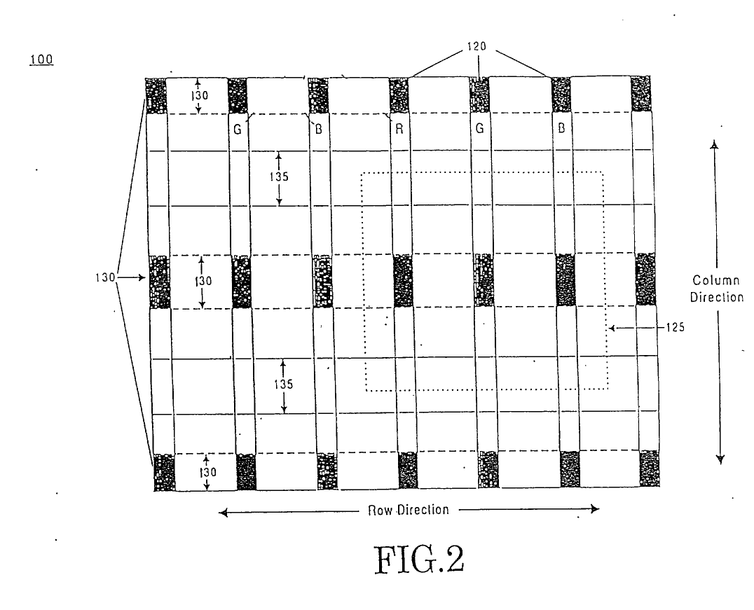

FIG. 2 illustrates a portion of an exemplary FED screen 100. The FED screen 100 is subdivided into an array of horizontally aligned rows and vertically aligned columns of pixels. The boundaries of a respective pixel 125 are indicated by dashed lines. Three separate row lines 130 are shown, and each row line 130 is a row electrode for one of the rows of pixels in the array. In one embodiment, each row line 130 is coupled to the emitter cathodes of each emitter in the particular row associated with the electrode. Alternately, each row line can be coupled to the gate electrode of each emitter in the particular row associated with the electrode. A portion of one pixel row is indicated in FIG. 2 and is situated between a pair of adjacent spacer walls 135. In an alternate embodiment, spacer walls 135 may not be present. A pixel row includes all of the pixels along one row line 130. Two or more pixel rows (e.g., 24-100 pixel rows) are generally located between each pair of adjacent spacer walls 135.

In color displays each column of pixels has three column lines 120; (1) one for red; (2) a second for green; and (3) a third for blue. Likewise, each pixel column includes one of each phosphor stripes (red, green, blue), three stripes total. In a monochrome display, each column contains only one stripe. In the present embodiment, each of the column lines 120 is coupled to the gate electrode of each emitter structure in the associated column. Alternatively, each of the column lines could be coupled to the emitter cathode of each emitter structure in the associated column. Further, in the present embodiment, the column lines 120 are coupled to column driver circuits (not shown) and the row lines 130 are coupled to row drivers circuits (not shown).

In operation the red, green and blue phosphor stripes are maintained at a high positive voltage relative to the voltage of the emitter-cathode 60/40. When one of the sets of electron-emission elements is suitably excited by adjusting the voltage of the corresponding row lines 130 and column lines 120, elements 40 in that set emit electrons which are accelerated toward a target portion 30 of the phosphors in the corresponding color. The exited phosphors then emit light. During a screen frame refresh cycle (performed at a rate of approximately 60 HZ in one embodiment), only one row is active at a time and the column lines are energized to illuminate the one row of pixels for the on-time period. This is performed sequentially in time, row by row until all pixel rows have been illuminated to display the frame. The above FED configuration is described in more detail in the following United States Patents: U.S. Pat. No. 5,541,473 issued on Jul. 30, 1996 to Duboc, Jr. et al.; U.S. Pat. No. 5,559,389 issued on Sep. 24, 1996 to Spindt et al.; U.S. Pat. No. 5,564,959 issued on Oct. 15, 1996 to Spindt et al.; and U.S. Pat. No. 5,578,899 issued Nov. 26, 1996 to Haven et al.; which are incorporated herein by reference.

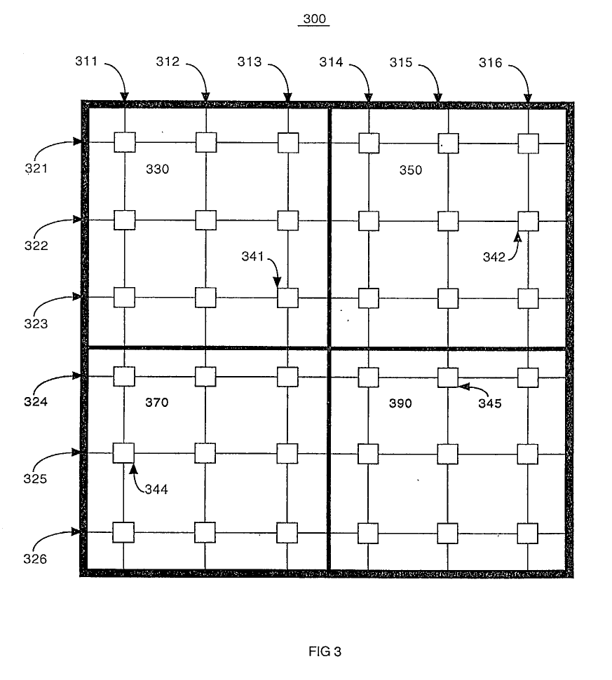

FIG. 3 is an schematic of FED 300, one embodiment of the present invention. FED 300 comprises pixels (e.g., 341, 342, 345, etc.) aligned in rows 321 through 326 and columns 311 through 316. The pixels include emitters on a backplate structure and are assigned to plurality of emitters uniformity areas 330, 350, 370, and 390. The emitters in a given emitter uniformity area provide a relatively uniform brightness. One of the emitter uniformity areas is designated as a primary emitter uniformity area. The voltage values of the “secondary” remaining plurality of emitter areas are adjusted to reach a uniformity with the primary emitter uniformity area. A uniformity area of the present invention can take a variety of configurations and shapes.

The components of FED 300 cooperatively operate to improve display uniformity. In one embodiment of the present invention, an altered voltage value function is applied to the “secondary” emitters. In one exemplary implementation, an emitter uniformity area adjustment table (e.g., stored in a memory coupled to FED 300) is utilized to adjust the voltage values of the emitters. For example, an emitter uniformity area adjustment table provides a correlation between a pixel location and a brightness level adjustment factor or setting. In one exemplary implementation, emitters have brightness levels of 0 to 255. When rendering of a particular pixel address is performed the brightness level is adjusted by a factor indicated in the emitter uniformity area adjustment table. For example, an adjustment factor or setting of 0.7 on a “red” emitter, 0.8 on a blue emitter and 0.5 on a green. In one embodiment of the present invention, the emitter uniformity area adjustment tables are utilized to create a software filtering mask to compensate for uniformity differences between different spots or areas in the display.

The present invention is readily adaptable to a variety of implementations. The “size” or number of pixels includes in a emitter uniformity area can range from one pixel to the number of pixels in half of the display. In one embodiment of the present invention, the primary emitter uniformity area is the one with the average dimmest brightness. The secondary remaining emitter uniformity areas are subjected to adjustments that bring their average brightness down to the same level as the primary brightness area. In one embodiment of the present invention, a variety of emitter uniformity area adjustment tables are provided and each one is directed to a user desired objective. In one exemplary implementation, there are a variety of tables with values between a maximized uniformity and a maximized brightness. A selector indicator enables a user to select between maximized uniformity and maximized brightness. This enables a user to select better uniformity for applications in which uniformity is desirable and maximum brightness for applications in which brightness is desirable.

The emitter uniformity areas are adaptable to a variety of configurations. In one embodiment of the present invention the emitter uniformity areas are configurable in a concentric pattern from the center of the display to the outer areas of the display. In one exemplary implementation, the adjustment factors in each emitter uniformity area are set to achieve different objectives. For example, central emitter uniformity areas can be set to relatively strict uniformity constraints and outer emitter uniformity areas (e.g., more in the user's peripheral vision) with dimmer brightness can be set to relatively higher brightness constraints.

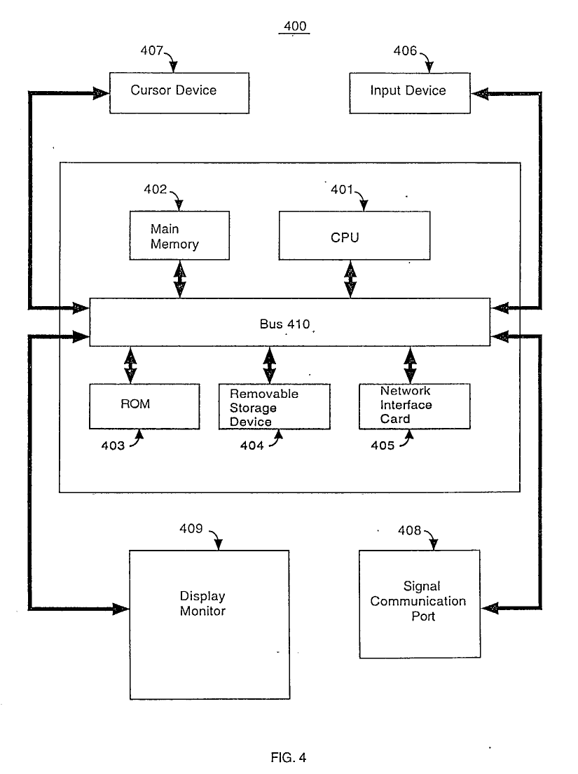

FIG. 4 is a block diagram of computer system 400, one embodiment of a computer system upon which the present invention is implemented. Computer system 400 includes address/data bus 410, central processor unit 401, main memory 402 (e.g., random access memory), static memory 403 (e.g., read only memory), removable data storage device 404, network interface card (NIC) 405, input device 406 cursor device 407, display monitor 409, and signal communications port 408. Address/data bus 410 is coupled to central processor units 401A, 401B, 401C, main memory 402, static memory 403, removable data storage device 404, network interface card 405, input device 406 cursor device 407, display monitor 409, and signal communications port 408.

The components of computer system 400 cooperatively function to provide a variety of functions, presentation of information on display monitor 409 with automatic adjustments for adverse emission changes. Address/data bus 410 communicates information, central processor 401 processes information and instructions, main memory 402 stores information and instructions for the central processor 401 and static memory 403 stores static information and instructions. Removable data storage device 404 provides also stores information and instructions (e.g., functioning as a large information reservoir). NIC 405 coordinates the communication of information to and from computer system 400 via signal communication port 408. Display device 409 displays information with automatic adjustments for adverse emission characteristics. Cursor device provides a mechanism for pointing to or highlighting information on the display device. Input device 406 provides a mechanism for inputting information.

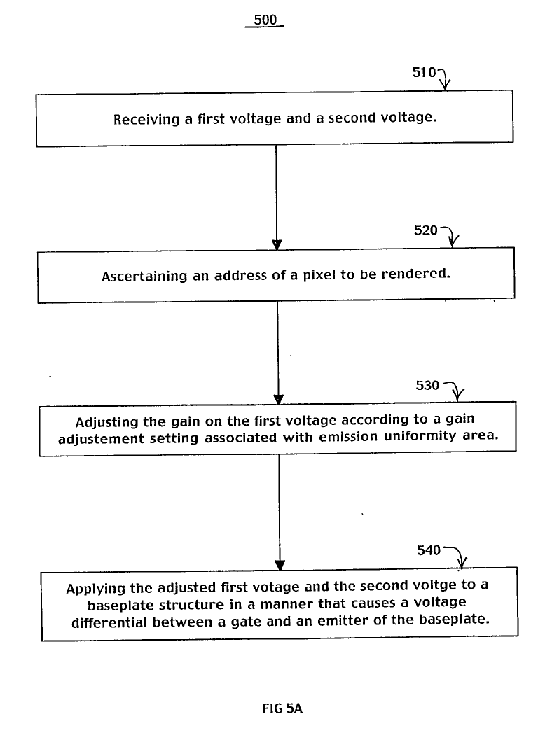

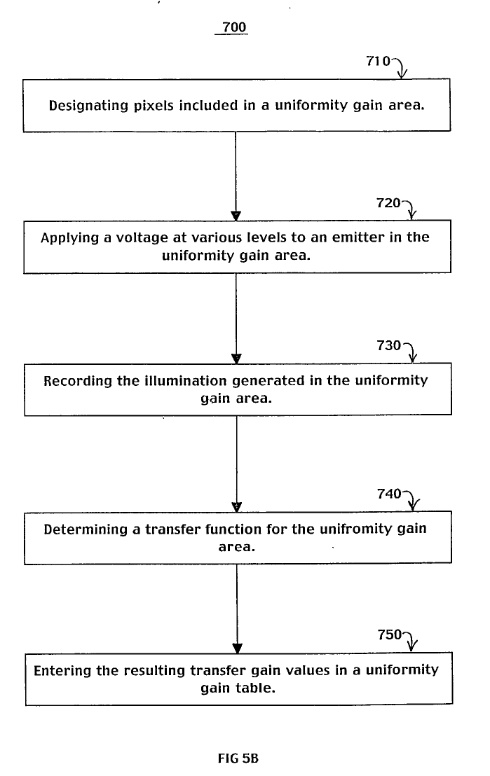

FIG. 5A is a flow chart of an emitter uniformity adjustment process 500, one embodiment of a present invention emitter uniformity adjustment process. Emitter uniformity adjustment process 500 facilitates greater uniformity in display brightness.

In step 510, a first voltage and a second voltage are received. In one embodiment of the present invention the first voltage and second voltage are supplied from a voltage source.

An address for a pixel to be rendered is ascertained in step 520. In one embodiment of the present invention, pixels are rendered in a pattern (e.g., raster, row by row, row column matrix, etc.) generated across pixels rows and columns of the display. In one exemplary implementation, the pixel addresses are ascertained by determining the next pixel in the pattern.

At step 530 the voltage value of the first voltage is adjusted according to adjustment settings associated with an emission uniformity area. In one embodiment of the present invention, the adjustment settings are included in a uniformity area adjustment table. The first voltage is adjusted according to the settings in the uniformity area adjustment table for emitters in a given pixel. In one embodiment of the present invention, a user preference indication process is utilized to indicate desired adjustments. In an exemplary implementation of a user preference indication process, an indication of a user uniformity objective is received, a uniformity area adjustment table corresponding to the user uniformity objective is retrieved, and the retrieved uniformity area adjustment table is utilized to establish the voltage value adjustment settings.

In step 540, the adjusted first voltage and the second voltage are applied to a baseplate structure in a manner that creates a voltage differential between a gate and an emitter of the baseplate. For example, the uniformity adjusted first voltage is applied to electron-emissive element 40 via emitter electrode 60 and the second voltage is applied to a gate electrode 50.

FIG. 5B is a flow chart of a uniformity adjustment table formation process 700, one embodiment of a present invention uniformity adjustment table formation process.

In step 710, pixels included in a uniformity adjustment area are designated. The designated areas can take on various shapes. For example the designated areas can be on a gradiant of the display or they can occupy a concentric arrangement.

In step 720 voltage at various levels is applied to the emitters in the uniformity adjustment area. In one embodiment of the present invention the voltage levels are divided up into levels from 0 to 255. In one exemplary implementation the voltage levels range from a lowest voltage to a highest voltage.

In step 730, the illumination generated in the uniformity adjustment area at each voltage level is recorded. In one exemplary implementation the brightness levels range from a lowest brightness to a highest brightness.

In step 740, a transfer function is determined for the area. In one embodiment of the present invention, the transfer function provides a correlation between the voltage level provided to emitters included in the area and the output intensity.

In step 750, the resulting transfer adjustment values are entered in the uniformity adjustment table. In one embodiment of the present invention, settings are entered into several different uniformity adjustment tables based upon a user objective.

Thus, the present invention is a system and method that facilitates comprehensible and clear presentation of information. The present invention provides greater display presentation uniformity. The present invention provides a accurate measure of what an appropriate change is and can either increase or decrease the drive in an effort to bring the current to levels that present a uniform appearance.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A baseplate structure rendering process:
receiving a first voltage and a second voltage;
ascertaining an address for a pixel to be rendered;
adjusting value of said first voltage in accordance with uniformity adjustment settings associated with an emission uniformity area; and
applying said adjusted first voltage and said second voltage to a baseplate structure in a manner that creates a voltage differential between a gate and an emitter of said baseplate.

2. The baseplate structure rendering process of claim 1 wherein said uniformity adjustment settings are included in a uniformity area adjustment table.

3. The baseplate structure rendering process of claim 2 wherein said first voltage is adjusted according to said adjustment values in said uniformity area adjustment table for emitters in a given pixel.

4. The baseplate structure rendering process of claim 1 wherein a user preference indication process is utilized to indicate desired adjustments.

5. The baseplate structure rendering process of claim 4 further comprising:
receiving an indication of a user uniformity objective;
retrieving a uniformity area adjustment table corresponding to said user uniformity objective; and
utilizing said retrieved uniformity area adjustment table to establish said uniformity adjustment settings.

6. The baseplate structure rendering process of claim 1 wherein pixels are rendered in a pattern generated across pixels rows and columns of the display.

7. The baseplate structure rendering process of claim 6 wherein said adjusted first voltage is applied to one of said columns.

8. The baseplate structure rendering process of claim 6 pixels wherein the pixel addresses are ascertained by determining the next pixel in the pattern.

9. A uniformity adjustment table formation process comprising:
designate pixels included in a uniformity adjustment area;
apply voltage at various levels to the emitters in said uniformity adjustment area;
record the illumination generated in the uniformity adjustment area at each voltage level;
determine a transfer function for the area; and
enter the resulting transfer adjustment values in the uniformity adjustment table.

10. A uniformity adjustment table formation process of claim 9 wherein uniformity adjustment area takes on different shapes.

11. A uniformity adjustment table formation process of claim 9 wherein the voltage levels are divided up into levels from a lowest voltage to a highest voltage.

12. A uniformity adjustment table formation process of claim 9 wherein the transfer function provides a correlation between the voltage level and brightness intensity.

13. A uniformity adjustment table formation process of claim 9 the transfer function provides a correlation between the voltage level provided to emitters included in the area and the output intensity.

14. A uniformity adjustment table formation process of claim 9 settings are entered into several different uniformity adjustment tables based upon a user objective.

15. An emission adjusting display device comprising:
a faceplate structure for generating an image; and
a backplate structure including a plurality of uniformity emitters areas,
wherein one of said plurality of emitter areas is designated as a primary uniformity emitter area and adjustments on remaining said plurality of emitter areas are adjusted to reach a uniformity with said primary uniformity emitter area.

16. The emission adjusting display device of claim 15 wherein said values are altered by a voltage value function.

17. The emission adjusting display device of claim 15 wherein an emitter uniformity area adjustment table is utilized to provide a correlation between a pixel location and a brightness level.

18. The emission adjusting display device of claim 17 wherein said uniformity area adjustment table is utilized to form a uniformity mask.

19. The emission adjusting display device of claim 17 adjustment are made in quantified level of steps.

20. The emission adjusting display device of claim 17 wherein said uniformity emitter areas are arranged in a concentric pattern.
